(19) United States
(12) Patent Application Publication
(10) Pub. No.: US 2011/0125385 A1
(43) Pub. Date: May 26, 2011

(54) CONTROL DEVICE OF A MOTOR VEHICLE AND METHOD FOR EXCHANGING CONTROL AND REGULATING SIGNALS

(75) Inventors: Volker Eichenseher, Beratrzhausen (DE); Hans Hurt, Alteglofsheim (DE); Hortst Simon, Regensburg (DE)

(73) Assignee: CONTINENTAL AUTOMOTIVE GMBH, HANOVER (DE)

(21) Appl. No.: 13/055,753

(22) PCT Filed: Jul. 27, 2009
(86) PCT No.: PCT/EP2009/005438

§ 371 Date: Jan. 25, 2011

(30) Foreign Application Priority Data
Jul. 25, 2008 (DE) 10 2008 034 681.0

(51) Int. Cl. F02D 28/00; G06F 19/00

(52) U.S. Cl. 701/102; 701/1

(57) ABSTRACT

A control device for carrying out a method of exchanging control and regulating signals in a motor vehicle includes a central control unit which is an integrated semiconductor circuit and which is disposed on at least one circuit board. At least one driver unit is disposed as a further integrated semiconductor circuit in the control device for monitoring and controlling an application. The driver unit interacts with the central control unit. For this purpose, the central control unit includes a first optical transceiver, the driver unit includes a further optical transceiver and the transceivers are optically coupled for data exchange.

The invention relates to a control device of a motor vehicle and a method for exchanging control and regulating signals. For this purpose the control device has a central control unit. The central control unit forms an integrated semiconductor circuit. In this arrangement the central control unit is disposed on at least one circuit board. At least one driver unit is disposed in the control device as a further semiconductor circuit for the purpose of monitoring and controlling at least one application. In this case the driver unit cooperatively interacts with the central control unit on the one hand and with the application on the other.

The data rate at which it is necessary to transmit data from one integrated semiconductor circuit to the next integrated semiconductor circuit in motor vehicle control devices of the aforesaid kind is increasing all the time. This means that increasingly more data lines and more data links are required in order to transport the information to the point where it is needed. The data rate in this case can range between several megabits and up to several gigabits.

In the control devices for motor vehicles the links between two integrated semiconductor circuits are currently implemented by means of electrical connections and/or wirings on a circuit board. As the data rates increase, so does the requirement to fulfill the electromagnetic compatibility conditions for each of the individual connections on the circuit board and inside the control device. At the same time it is desired to suppress electromagnetic noise and electromagnetic interference to the greatest extent possible. Toward that end the electrical connections must be kept as short as possible. This means that the integrated semiconductor circuits should be positioned as close as possible to one another. However, this requirement reduces the spatial flexibility for structuring circuit boards.

The object of the invention is to provide a control device for a motor vehicle by means of which the electrical data lines and data links can be reduced in spite of increasing volumes of data requiring to be transmitted. A further object of the invention is to improve the electromagnetic compatibility in spite of increased data transfer rates of the control device.

This object is achieved by means of the subject matter of the independent claims. Advantageous developments of the invention will emerge from the dependent claims.

A control device of a motor vehicle and a method for exchanging control and regulating signals are provided according to the invention. For this purpose the control device has a central control unit which is an integrated semiconductor circuit and is disposed on at least one circuit board. At least one driver unit is disposed in the control device as a further integrated semiconductor circuit for the purpose of monitoring and controlling an application, the driver unit cooperatively interacting with the central control unit. To that end the central control unit has a first optical transceiver and the driver unit has a further optical transceiver, said transceivers being optically coupled for the purpose of exchanging data.

This control device has the advantage that the optical coupling exhibits a high level of electromagnetic compatibility and causes no electromagnetic emissions whatsoever. Furthermore the first transceiver can be disposed at a minimal distance from or even on the central control unit, that is to say on the first semiconductor circuit, while the further optical transceiver of the optical coupling can be disposed at a greater distance from the first optical transceiver without any electromagnetic interference.

This results in a high level of flexibility in terms of the spatial arrangement both of the two transceivers and of the associated integrated semiconductor circuits of the central control unit as well as of the driver unit on one circuit board. Finally it is a further advantage that an optical coupling by way of transceivers can transmit a higher data rate than is possible with the electrical connecting leads. The high level of flexibility of this solution enables the optical coupling between central control element and a driver unit to be implemented on the same circuit board and consequently on the same circuit level. On the other hand it is also possible to provide a folded circuit board in such a way that two halves of the circuit board are positioned opposite each other, with the result that the two transceivers are disposed one opposite the other. Furthermore it is possible to utilize the flexibility of this solution to the effect that the two circuit boards are disposed at an angle to each other, and that the two transceivers communicate with each other at such an angle.

Moreover there are different possibilities of performing an exchange of data, for example by means of unidirectional communication in which a first semiconductor chip sends electrical data to an optical transmitter. The transmitter converts the electrical signals into optical signals and transmits the latter to an optical receiver of the further integrated circuit, to the driver unit for example. In this case the further transceiver converts the optical signals into electrical signals which can then be received by the second semiconductor chip and converted for example into switching or control signals.

In addition to said unidirectional communication, bidirectional communication is also possible, for example by way of two optical coupling paths in which both an optical sensor and an optical receiver are disposed on each side, such that signals can be transmitted in both directions simultaneously, each semiconductor component being assigned an optical receiver and an optical transmitter for the purpose of said bidirectional communication. Finally it is also possible to implement a bidirectional communication by means of just one optical coupling, in which case the above-mentioned transceivers are used for this purpose, with an optical sensor and an optical receiver being disposed inside a single optical component and consequently also only a one-time alignment of a first transceiver to a further transceiver being required.

An optical coupling can be implemented in different media. In one embodiment variant of the invention an air atmosphere is preferably made available for the optical coupling. Flexibility is highest with this type of coupling. In a further preferred embodiment variant the optical coupling is provided in an inert gas atmosphere. In this case the first transceiver and the second transceiver are contained in a hermetically sealed housing filled with inert gas such as nitrogen or noble gas. Both for use in an air atmosphere and for use in an inert gas atmosphere it is necessary for the optical axes of the two transceivers to be aligned with each other or be combined with each other via corresponding reflection surfaces.

A very high level of flexibility is achieved by means of a fiber-optic coupling in which an optical waveguide is provided in the form of a light-transmissive and light-concentrating fiber. Since such fibers are very flexible the two transceivers can be set up at widely different angles to each other. This increases the design flexibility of circuit boards because a precise adjustment between optical transmitter and optical receiver is not necessary as a prerequisite.

Preferably the control device is disposed in the motor vehicle as an engine control device. In this case, however, in addition to monitoring and controlling the different operating states and assemblies of the engine the engine control device can also control further components of the vehicle, for example the vehicle's anti-lock braking system, the vehicle's heating and air conditioning system, the vehicle's exhaust system with the different lambda probes of a multiway catalytic converter, the vehicle's accelerator pedal sensor, as well as a multiplicity of pressure and temperature information that requires evaluation and data processing.

Preferably, however, the control device is disposed in the motor vehicle as an engine control device which controls both the high-pressure fuel pump and the low-pressure fuel pump, monitors the supercharging pressure, controls the variable camshaft settings and the camshaft nominal lobe lift or the coolant throughput, and regulates much more.

In a preferred embodiment variant of the invention the central control unit is disposed with the first optical transceiver on a first circuit board and the at least one driver unit is disposed with the further optical transceiver on a further circuit board. In this arrangement these circuit boards are aligned with respect to each other in such a way that an optical coupling of the transceivers is present.

This optical coupling by way of air or inert gas for example can be achieved in that the two circuit boards of the central control unit and of the driver unit are disposed opposite each other. In order not only to ensure the optical coupling, but also to enable electrical feed lines, supply lines and the like between the two circuit boards, the two circuit boards can be electrically and mechanically coupled, wherein in a first embodiment variant of said circuit boards these are connected to each other by way of a thinned flexible section of the circuit boards.

A thinned flexible section of this kind is achieved in that part of the core material of the board is removed in order to reduce the rigidity of the circuit board in this region. Another possibility is, in addition to the optical coupling, to connect the two oppositely disposed circuit boards electrically and/or mechanically to each other by way of a flexible multiconduction band or a bus. However, a flexible connection of this kind requires complex multiple pin connectors on the circuit boards.

A flexible electrical and/or mechanical coupling of this kind can assume any arbitrary angle as long as it is ensured that an optical coupling between the two circuit boards or, as the case may be, the two transceivers is guaranteed. This can be achieved in that the two component sides of the circuit boards are disposed opposite each other. On the other hand it is possible to insert an optical waveguide between the two optical transceivers which, by virtue of its flexibility, optically couples the two optical transceivers to each other.

In addition to a first individual transceiver the central control unit can also have a plurality of first transceivers that are optically coupled to a plurality of further transceivers of further integrated semiconductor circuits. In this way it is possible to control a plurality of driver units directly from the central control unit without having to provide additional electrical leads.

A preferred method for exchanging control and regulating signals in a control device has the following method steps. Volumes of sensor data are initially received in a central control unit. Said volumes of sensor data are buffered in the central control unit and processed into signal data for drivers connected downstream. Said signal data is then converted into optical signals and emitted by an optical transmitter of a transceiver. The driver unit cooperates with an optical receiver so that the optical signals can be received in the at least one driver unit. There, the optical signals are converted into electrical control pulses by means of which the different applications can be controlled. Individual applications have already been cited above by way of example, so a repetition will be dispensed with at this juncture. An optical coupling for the purpose of emitting and receiving optical signals can be realized in an air atmosphere, in an inert gas atmosphere or by way of a fiber-optic coupling.

The control device preferably performs control functions of a motor vehicle, in particular engine control functions. For this purpose the central control unit having the first optical transceiver is mounted on a first circuit board, and the at least one driver unit having the further optical transceiver is disposed on a further circuit board, the boards being aligned with respect to each other in such a way that an optical coupling of the transceivers is realized. Toward that end, for example, the component sides of two circuit boards are disposed opposite each other so that the two transceivers can be optically coupled. On the other hand it is also possible for the two boards to be disposed at an angle to each other and for the optical transceivers to communicate with each other by way of a flexible optical waveguide.

The invention will now be explained in more detail with reference to the attached figures, in which:

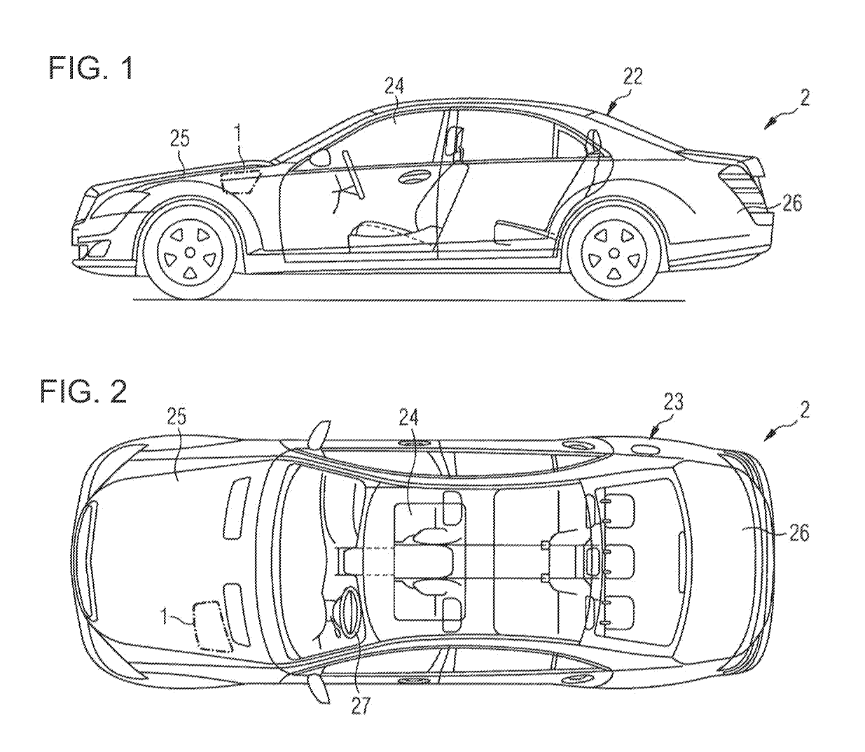

FIG. 1 shows a schematic side view of vehicle with control device according to an embodiment variant of the invention;

FIG. 2 shows a schematic plan view onto the vehicle according to FIG. 1;

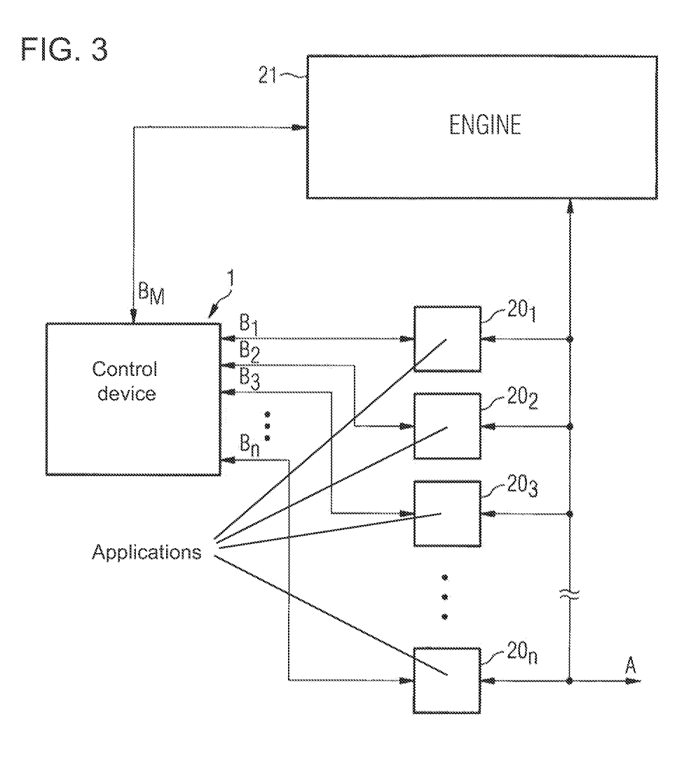

FIG. 3 is a schematic diagram showing a control device according to an embodiment variant of the invention in cooperative interaction with applications;

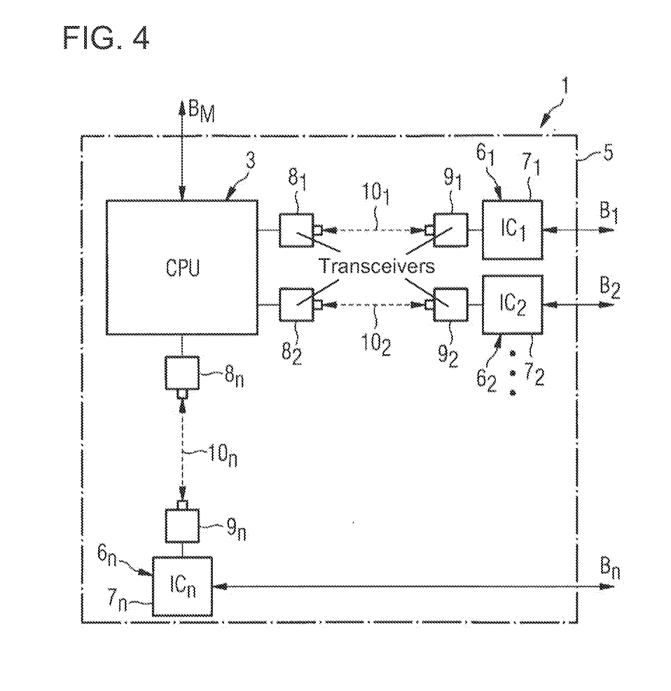

FIG. 4 is a schematic diagram showing a central control unit having a plurality of optical couplings;

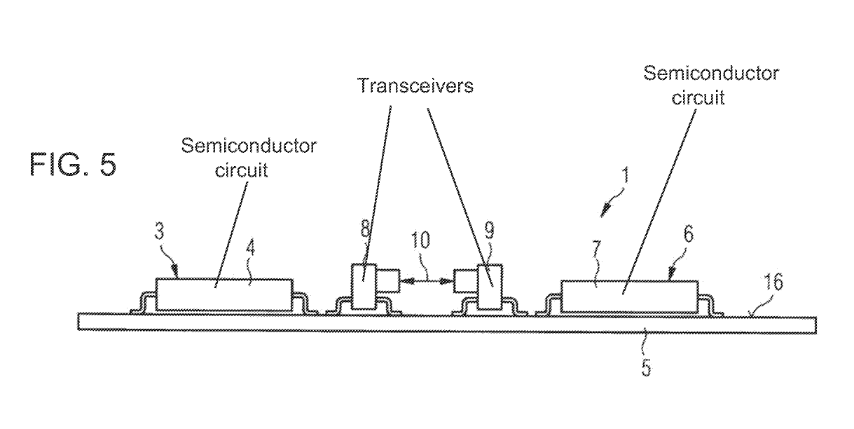

FIG. 5 is a schematic diagram showing a circuit board having a control device according to an embodiment variant of the invention;

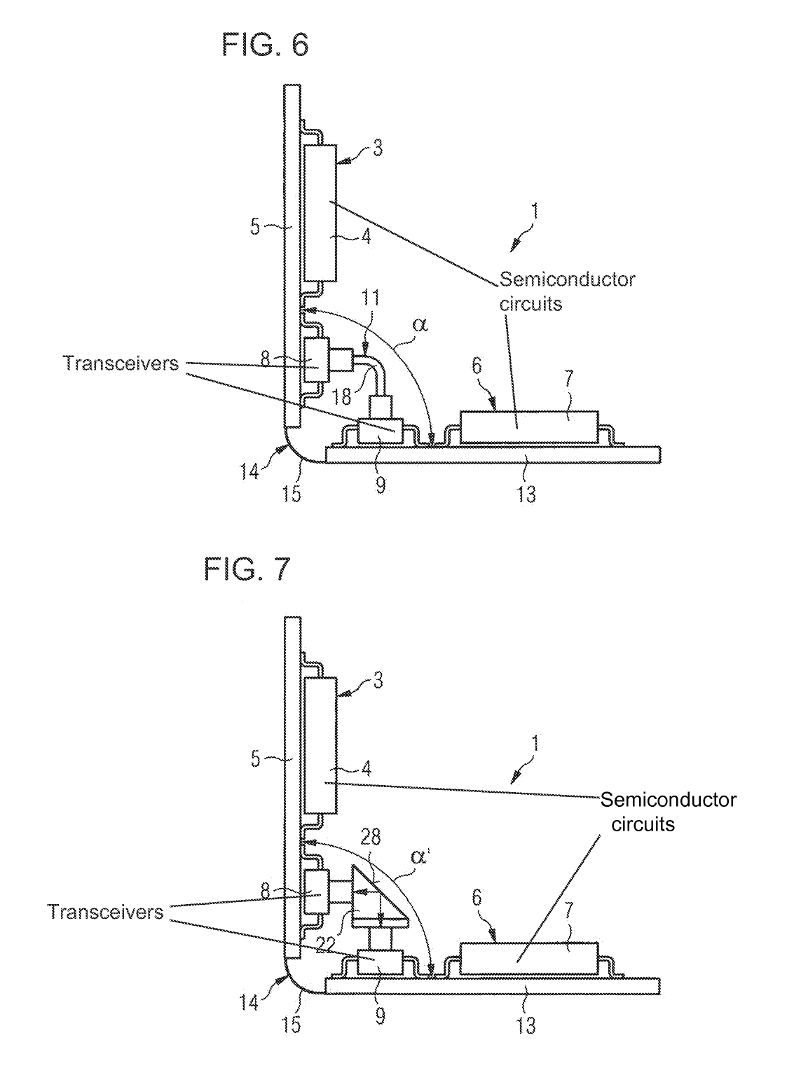

FIG. 6 is a schematic diagram showing a bent-over circuit board having a fiber-optic coupling of transceivers according to a further embodiment variant of the invention;

FIG. 7 is a schematic diagram showing a bent-over circuit board having a prismatic optical coupling of transceivers according to a further embodiment variant of the invention; and

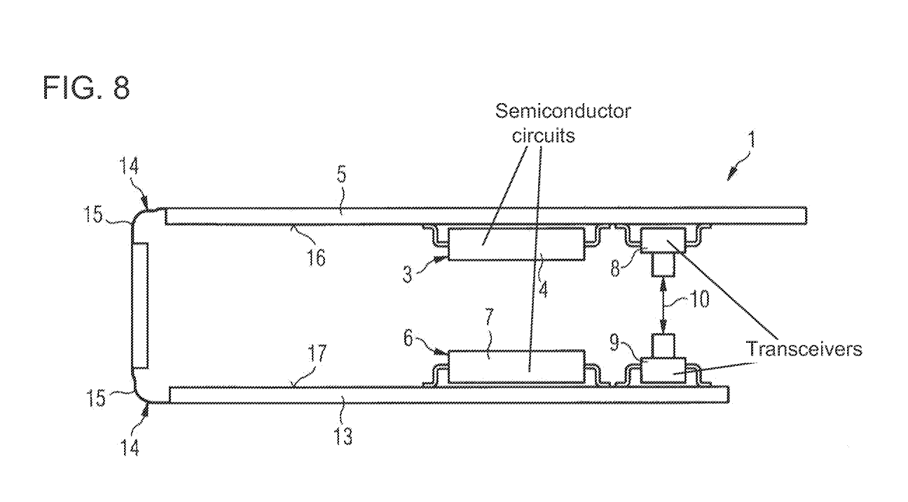

FIG. 8 is a schematic diagram showing circuit boards disposed opposite each other and having a surrounding material.

FIG. 1 shows a schematic side view 22 of a vehicle 2 with control device 1 according to an embodiment variant of the invention. In this embodiment variant of the invention the control device 1 is accommodated in the engine compartment 25 of the vehicle 2. In principle it can, however, also be disposed in the trunk area 26 or in the passenger compartment 24 of the vehicle 2. In this case a control device 1 in the trunk area 26 is less exposed to risk of contamination than in the engine area 25. Finally the control device 1 is protected even better against vibrations if it is accommodated in the passenger compartment 24.

FIG. 2 shows a schematic plan view onto the vehicle 2 according to FIG. 1. Components having like functions to those in FIG. 1 are labeled with like reference numerals and not explained further. FIG. 2 illustrates that the control device 1 is disposed in the engine compartment 25 on the driver side 27. This enables the cable loom to the control device 1 to be optimized since a significantly higher number of applications for the control device 1 are disposed on the driver side 27 than on the front passenger side or even in the trunk area 26. Nonetheless, a protective housing for the control device 1 is subject to more stringent requirements when the control device 1 is disposed in the engine compartment 25, since it is necessary to provide protection not only against vibrations and contaminations but also against extreme temperatures in the engine compartment 25.

FIG. 3 is a schematic diagram showing a control device 1 according to an embodiment variant of the invention in cooperative interaction with applications 20₁, 20₂, 20₃ to 20ₙ. Applications of this kind can be actuating elements that are driven by corresponding driver units in the control device 1. The applications also include all the components and assemblies that cooperatively interact with the engine 21. These too are controlled and/or regulated by the control device 1. The arrow directions of the connections B₁, B₂, B₃ to Bₙ between the applications 20₁, 20₂, 20₃ to 20ₙ and the control unit 1 are bidirectionally oriented since a multiplicity of actuating, temperature and pressure information must be delivered to the control device 1, to which information, conversely, the driver units of the control device 1 respond in order to control the different applications. It is not necessary for every one of the applications 20₁, 20₂, 20₃ to 20ₙ to communicate with components of the engine 21. This is indicated by the arrow direction A.

FIG. 4 is a schematic diagram showing a central control unit 3 having a plurality of optical couplings 10₁, 10₂ to 10ₙ. Each of these optical couplings 10₁, 10₂ to 10ₙ supports an exchange of signals between a plurality of transceivers 8₁, 8₂ to 8ₙ on the side of the central control unit 3 and corresponding transceivers 9₁, 9₂ to 9ₙ on the side of different driver units 6₁, 6₂ to 6ₙ which preferably consist of integrated circuits 7₁, 7₂ to 7ₙ. The central control unit 3 is also built from an integrated semiconductor circuit 4. The outputs B₁, B₂ to Bₙ of the driver units 6₁, 6₂ to 6ₙ cooperatively interact with corresponding applications, as shown in FIG. 3.

FIG. 5 is a schematic diagram showing a circuit board 5 having a control device 1 according to a further embodiment variant of the invention. In this case a central control unit 3 having an integrated semiconductor circuit 4 that is interconnected with a first optical transceiver 8 is disposed on a component side 16 of a circuit board 5, electrical signals being transmitted from the central control unit 3 to the first optical transceiver 8 and back again. The optical transceiver 8 converts the electrical signals into optical signals and can be operated bidirectionally, i.e. it can not only send optical signals, but also receive optical signals via the optical coupling 10.

The receiver of the optical transceiver 9 cooperatively interacts with a further semiconductor circuit 7 that belongs to a driver unit 6. The further transceiver 9 can receive optical signals via the optical coupling 10 because the two transmit and receive units of the transceivers 8 and 9 are optically aligned with each other. The optical transceiver 9 converts incoming optical signals into electrical signals which are passed on to the integrated circuit 7 of the driver unit 6, the driver unit 6 cooperatively interacting with one or more applications, as shown in FIG. 3, and passing on corresponding control, switching and/or adjusting signals to said applications. In the embodiment variant according to FIG. 5 the central control unit 3 and the driver unit 6 are disposed on a single circuit board 5, whereas in the following figures further advantageous arrangements for the central control unit 3 and the driver unit 6 are shown.

FIG. 6 is a schematic diagram showing a bent-over circuit board 5 which is disposed at an angle α of almost 90° with respect to a further board 13. Whereas on the circuit board 5 as shown in FIG. 5 the central control unit 3 is disposed together with the associated first optical transceiver 8, on the circuit board 13 the driver unit 6 is mounted together with the associated further transceiver 9. The transceivers standing at an angle α to each other are coupled to each other by way of a flexible fiber-optic coupling 11 in the form of a flexible optical waveguide 18. At the same time the circuit boards 5 and 13 are connected to each other via an electrical and/or mechanical coupling 14 composed of a thinned flexible section 15 of the circuit boards 5 and 13. This means that the circuit boards 5 and 13 were initially fabricated from a single common circuit board and thinned to produce the flexible section 15. This has the advantage of a minimization of the required installation space, since no plug-in modules need to be provided in order to couple the circuit boards 5 and 13 electrically and mechanically to each other.

On the other hand it is also possible to connect the two circuit boards 5 and 13 to each other via a line bus or via a flexible multiconduction band. The advantage of the arrangement shown in FIG. 6 is that the angle α can be changed arbitrarily without affecting the optical transmission path, with the result that vibrations of the vehicle do not have an impact on the quality and reliability of the optical coupling.

FIG. 7 is a schematic diagram showing a bent-over circuit board 5 having a prismatic optical coupling according to a further embodiment variant of the invention. Components having like functions as in FIG. 6 are labeled with like reference numerals and not explained further. Disposed between the transceiver 8 and the transceiver 9 is a prism 22 which must be adjusted with its reflecting surface 28 exactly to the angle α between the two circuit boards 5 and 13 in order to couple the optical axes of the transceivers 8 and 9 to each other.

FIG. 8 is a schematic diagram showing circuit boards 5 and 13 disposed opposite each other, wherein the optoelectronic components, i.e. the transceivers 8 and 9 are aligned with each other in such a way that the optical coupling 10 can be realized by way of the surrounding gaseous material. A gaseous material of such kind can include air and/or inert gas. This embodiment variant of the invention has the advantage that it can be constructed very compactly and consequently takes up only a small volume. Furthermore the susceptibility to interference and faults of such an embodiment variant is low and its reliability correspondingly improved. The space between the component side 16 of the circuit board 5 and the component side 17 of the circuit board 13 can also be filled with an optically transparent material such that the optical coupling is realized by means of said material. This has the advantage that vibrations of the vehicle cannot adversely affect the quality of the optical coupling. A further advantage results from the fact that a control device of this kind can be implemented as a compact encapsulated control block.

1-22. (canceled)

23. A control device of a motor vehicle, the control device comprising:
first and second circuit boards disposed at an angle relative to each other and not in the same plane;
a central control unit configured as an integrated semiconductor circuit and having a first optical transceiver, said central control unit and said first optical transceiver being disposed together on said first circuit board;
at least one driver unit configured as a further integrated semiconductor circuit for monitoring and controlling an application, said at least one driver unit cooperatively interacting with said central control unit, said at least one driver unit having a further optical transceiver and said at least one driver unit and said further optical transceiver being disposed together on said second circuit board; and
a flexible optical waveguide disposed between and optically coupling said optical transceivers to each other for exchanging data. (FIG. 6)

24. A control device of a motor vehicle, the control device comprising:
first and second circuit boards having component sides disposed opposite each other;
a central control unit configured as an integrated semiconductor circuit and having a first optical transceiver, said central control unit and said first optical transceiver being disposed together on said first circuit board;
at least one driver unit configured as a further integrated semiconductor circuit for monitoring and controlling an application, said at least one driver unit cooperatively interacting with said central control unit, said at least one driver unit having a further optical transceiver and said at least one driver unit and said further optical transceiver being disposed together on said second circuit board; and
said transceivers being optically coupled to each other for exchanging data. (FIG. 8)

25. The control device according to claim 24, wherein said optical coupling has an air atmosphere.

26. The control device according to claim 24, wherein said optical coupling has an inert gas atmosphere.

27. The control device according to claim 24, wherein said optical coupling is a fiber-optic coupling.

28. The control device according to claim 24, wherein the control device is an engine control device disposed in the motor vehicle.

29. The control device according to claim 24, which further comprises:
an optical coupling and an electrical and mechanical coupling connected between said circuit boards of said central control unit and of said driver unit;
said circuit boards having a thinned flexible section at which said circuit boards are connected to each other.

30. The control device according to claim 29, which further comprises a flexible multiconduction band or a bus line electrically and/or mechanically connecting said circuit boards to each other in addition to said optical coupling.

31. The control device according to claim 23, wherein the control device is an engine control device disposed in the motor vehicle.

32. The control device according to claim 23, which further comprises:
an optical coupling and an electrical and mechanical coupling connected between said circuit boards of said central control unit and of said driver unit;
said circuit boards having a thinned flexible section at which said circuit boards are connected to each other.

33. The control device according to claim 32, which further comprises a flexible multiconduction band or a bus line electrically and/or mechanically connecting said circuit boards to each other in addition to said optical coupling.
